(19) United States
(12) Patent Application Publication
(10) Pub. No.: US 2013/0160096 A1
(43) Pub. Date: Jun. 20, 2013

(54) SYSTEM AND METHOD OF PORTABLE SECURE ACCESS

(71) Applicant: Sridhar Nuthi, Sussex, WI (US)

(72) Inventor: Sridhar Nuthi, Sussex, WI (US)

(73) Assignee: GENERAL ELECTRIC COMPANY, Schenectady, NY (US)

(21) Appl. No.: 13/330,273

(22) Filed: Dec. 19, 2011

(51) Int. Cl. H04W 12/06; H04L 29/06

(52) U.S. Cl. 726/5

(57) ABSTRACT

An access system and method to establish communication with a customer system via a port is provided. The system can comprise a secure access key that can provide a communication link to the port on the customer system, and a footprint module. The footprint module can block connectivity via the port with the customer system unless the footprint module detects the secure access key as having a first authentication to connect to the customer system. A client device can communicate with the secure access key to get a second authentication from the secure access key to create a connection for communication via the secure access key with the customer system. The system can further comprise a user authentication module that requires a third authentication of a user to operate the client device to communicate over the secure connection via the secure access key with the customer system.

### TECHNICAL FIELD

The subject herein generally relates to a system and method to portable secure access, and more specifically, to a portable secure service access point to facilitate servicing of a system.

### BACKGROUND

Hospitals and other medical facilities (e.g., imaging centers, cardiology treatment centers, emergency rooms, surgical suites, etc.) include many medical equipment systems, some operable to deliver diagnosis of admitted patients. In the field of client medical equipment devices or systems where patient safety is one concern, various techniques have been employed to prevent access by unauthorized personnel to change settings or servicing the system.

One known secure service access device utilized by service personnel or field engineer is a secure service key that inserts to the system, similar to a inserting a key to unlock a car, to gain access to establish a hard-wired communication line with a laptop of the service personnel. One drawback of the above known secure service access device is an inability to provide secure connectivity to utilize software applications that run on wireless devices and smart phones.

The above-mentioned problem can be addressed by the subject matter described herein in the following description.

### BRIEF SUMMARY

The system and method of the subject matter described herein can be directed to provide a portable, secure access to service a customer system. The system and method can provide an ability to utilize software applications that run on wireless devices or smart phone to service systems. The system and method can enable secure connectivity to the customer system on demand to access a predefined subset of categories of software applications or to service a predefined subset of authorized customer systems.

According to one embodiment, an access system to establish communication with a customer system via a port is provided. The system can comprise a secure access key that can provide a communication link to the port on the customer system, and a footprint module. The footprint module can block connectivity via the port with the customer system unless the footprint module detects the secure access key as having a first authentication to connect to the customer system. A client device can communicate with the secure access key to get a second authentication from the secure access key to create a connection for communication via the secure access key with the customer system. The system can further comprise a user authentication module that requires a third authentication of a user to operate the client device to communicate over the secure connection via the secure access key with the customer system.

According to another embodiment, a method of establishing communication with a customer system via a port at the customer system is provided. The method can comprise the steps of: connecting a secure access key that provides a communication link to the port on the customer system; blocking connectivity of the secure access key to communicate over the port on the customer system unless a footprint module detects the secure access key as having a first authentication to connect to the customer system; blocking connectivity of the client device to communicate via the secure access key unless detecting a second authentication of the client device to use the secure access key; and blocking connectivity of the client device unless detecting a third authorization of a user to operate the client device to communicate over the secure connection via the secure access key with the customer system.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of an embodiment of a system that provides a portable secure access point to communicate with a customer system in accordance with the subject matter described herein.

FIG. 2 is a schematic diagram illustrating a method of operating the system in FIG. 1 in providing a portable secure access point to communicate with the customer system in accordance with subject matter described herein.

### DETAILED DESCRIPTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

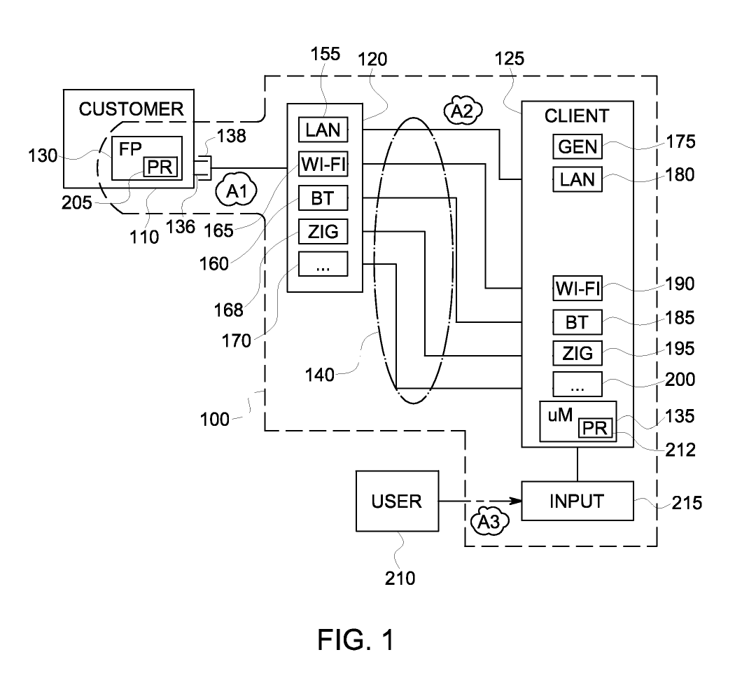

FIG. 1 illustrates a schematic diagram of an embodiment of an access system 100 to establish communication with a customer system 110 in accordance to the subject matter described herein. The access system 100 generally comprises a secure access key 120, a client device 125, a footprint module 130, and a user authentication module 135.

The customer system 110 can vary. Examples of the customer system 110 can include a radiological (e.g., X-ray, fluoroscopic, interventional, etc.) imaging system, a magnetic resonance (MR) imaging system, an ultrasound (US) imaging system, an anesthesia machine, an electrophysiology (EP) recorder, nuclear or positron emission transmission (PET) imaging system, molecular imaging system, biological reactor, etc. Although the above examples are of medically related systems, the customer system 110 can be other types of industrial or commercial type systems (e.g., servers) and is not limiting. The customer system 110 can include a port 136 to communicate with one or more multiple components and functions, as well as subsystems, and so forth on the customer system 110.

The secure access key 120 can be operable to provide or establish communication with the customer system 110 authorization of a first authentication of the secure access key 120. The secure access key 120 can include a hub (e.g., USB, M-Port, etc.) 138 operable to connect in communication at the respective port 136 of the customer system 110. The secure access key 120 can include a communication link 140 to communicate with the client device 125. The type of communication link 140 (e.g., a local area network (LAN), Bluetooth, wi-fi, etc.) can vary. The secure access key 120 can include a LAN communication module 155 to establish the LAN type communication link 140, a Bluetooth communication module 160 to establish the Bluetooth communication link 140, a wi-fi communication module 165 to establish the wi-fi type communication link 140, a Zigbee communication module 168 to establish a Zigbee communication link 140, or other known communication module 170 to establish another known type of communication link 140. The secure access key 120 can include all of the communication modules 155, 160, 165, 168, 170 described above to provide for multiple types of communication links 140 in the field as needed to communicate independently with a single client device 125 or simultaneously with multiple client devices 125.

The client device 125 can communicate via the secure access key 120 to create a connection for communication via the secure access key 120 with the customer system 110. One embodiment of the client device 125 can include a generator 175 of a second authentication signal (A2). The client device 125 can include a LAN communication module 180 to establish the LAN type communication link 140, a Bluetooth communication module 185 to establish the Bluetooth communication link 140, a wi-fi communication module 190 to establish the wi-fi type communication link 140, a Zigbee communication module 195 to establish the Zigbee communication link 140, or another known communication module 200 to establish another known type of communication link 140 with the secure access key 120. Examples of the client device 125 can include a laptop having wireless or network wired communication capability, or a smart phone having wireless communication capability.

The footprint module 130 can selectively allow or otherwise unblock connectivity to communicate via the port 136 with the customer system 110. The footprint module 130 can continue to block connectivity unless the footprint module 130 detects the secure access key 120 as having the first authentication to connect to the customer system. In response to detecting the first authentication, the footprint module 130 can then allow or unblock connectivity to communicate via the port 136 with the customer system 110. Examples of the footprint module 130 can include a plurality of program instructions for execution by a processor to perform as described above, or can include a programmable hardware operable to do the same. The footprint module 130 can be installed at the customer system 110, but the location of the footprint module 130 can vary (e.g., a master server connected to multiple customer systems 110, etc.). The first authentication can be a signal including an alphanumeric sequence or other form of identifier of the secure access key 120. The footprint module 130 can include program instructions for execution by a first processor 205 to compare the first authentication received from the secure access key 120 to stored database or values of authorized authentication identifiers.

The user authentication module 135 can be generally require a third authentication signal (A3) of a user 210 to operate the client device 125 to communicate over the secure connection via the secure access key 120 with the customer system 110. One embodiment of the user authentication module 135 can be computer program instructions for execution by a second processor 212 to receive a password or user identification from the user 210 via a keypad or similar input interface 215 on the client device 125.

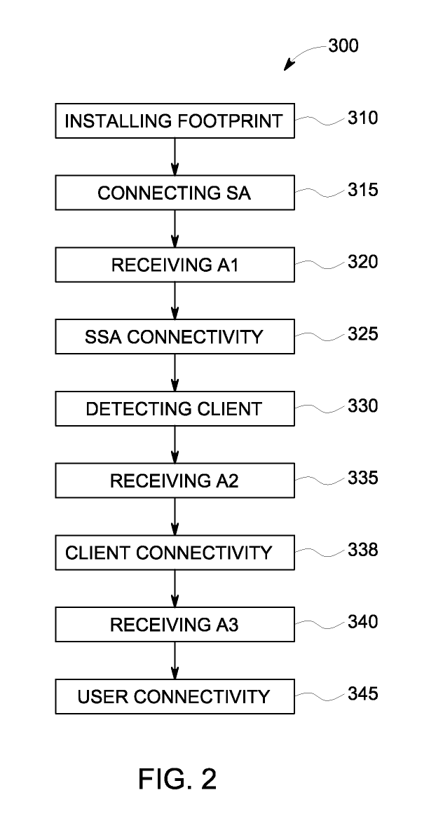

Having described the above general construction of the system, the following is description of the system in the operation of a method 300 in accordance to the subject matter described herein and as described in FIG. 2. It should also be understood that the sequence of the acts or steps of the method 300 as discussed in the foregoing description can vary. Also, it should be understood that the method 300 may not require each act or step in the foregoing description, or may include additional acts or steps not disclosed herein. It should also be understood that one or more of the steps of the method 300 can be represented by a module of computer-readable program instructions stored in the memory.

Step 310 can include installing the footprint module 130 as described above at the customer system 110. The footprint module 130 can be generally operative in blocking or preventing access to communicate via the port 136 with the customer system 110.

Step 315 can include connecting the secure access key 120 at the port 136 on the customer system 110. Step 320 can include receiving a first authentication signal A1 representative of an identifier of the secure access key 120. The footprint module 130 can receive the first authentication signal A1 via an encrypted file from the secure access key 120 as to get authorization from the footprint module 130. Step 325 can include unblocking or allowing or establishing connectivity of the secure access key 120 to communicate over the port 136 on the customer system 110 upon or in response to detecting the first authentication signal A1 to be authorized to connect to the customer system 110.

The secure access key 120 can be generally operative in blocking or preventing access to communicate via the service access key with the customer system. Step 330 can include the secure access key 120 detecting the client device 125. The step 330 can be automatically detected by the secure access key 120, or the user 210 can initiate the client detection of the client device 125 by the secure access key 120. Step 335 can include receiving the second authentication signal A2 representative of an identifier of the client device 125. The secure access key 120 can automatically detect or receive the second authentication signal A2 of the client device 125 via the Bluetooth, wi-fi, the LAN, or Zigbee communication links 140. Step 338 can include unblocking or allowing or establishing connectivity of the client device 125 to communicate via the secure access key 120 over the port 136 on the customer system 110 upon or in response to detecting the first authentication signal A2 to be authorized to connect to the customer system 110.

The user authentication module 135 can be generally operative in preventing or blocking the user 210 from using the client device 125 to communicate via the secure access key 120 with the customer system 110. Step 340 can include the user authentication module 135 receiving the third authentication signal A3 representative of the user 210 authorization of using the client device 125 via and the secure access key 120 to communicate with the customer system 110. Step 345 can include the user authentication module 135 unblocking or allowing or establishing connectivity for the user 210 of the client device 125 to communicate via the secure access key 120 upon or in response to detecting the third authentication signal A3 to be authorized to connect via the client device 125 and the secure access key 120 to communicate with the customer system 110. So upon or in response to getting the first, second and third authentications A1, A2, A3, the system 100 can allow or establish connection for the user 210 to communicate via the client device 125 and the secure access key 120 with the customer system 110. In one embodiment, secure access key 120 of the system 100 can be operative in automatically establishing a particular type of communication mode (e.g., LAN, Wi-Fi, Bluetooth, Zigbee, etc.) of the client device 125 to the secure access key 120 to be identical to the type of communication mode as detected in step 330 or the type of second authentication signal A2.

The footprint module 130 can be generally configured to limit access or only establish connectivity to a predefined set of categories of files or data on the customer system 110 dependent on at least one of the first, second and third authentications A1, A2, A3.

A technical effect of the above-described access system 100 and method 300 can include enabling a portable secure access point to service a customer system 110. The access system and method 300 can facilitate remote servicing of the customer systems 110 by providing for wired and wireless mediums in connecting to the customer system 110. The access system 100 and method 300 can provide an ability to utilize software applications that run on wireless devices or smart phone to service customer systems 110. The access system 100 and method 300 can enable secure connectivity to the customer system 110 on demand to access a predefined subset of categories of software applications or to service a predefined subset of authorized customer systems 110.

This written description uses examples to disclose the subject matter, including the best mode, and also to enable one skilled in the art to make and use the invention. The patentable scope of the subject matter is defined by the following claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An access system to establish communication with a customer system via a port, the system comprising:
a secure access key that provides a communication link to the port on the customer system;
a footprint module, where the footprint module blocks connectivity via the port with the customer system unless the footprint module detects the secure access key as having a first authentication to connect to the customer system;
a client device that communicates with the secure access key to get a second authentication from the secure access key to create a connection for communication via the secure access key with the customer system;
a user authentication module that requires a third authentication of a user to operate the client device to communicate over the secure connection via the secure access key with the customer system.

2. The access system of claim 1, wherein the service access key includes a USB hub to connect at the port on the customer system.

3. The access system of claim 1, wherein the secure access key provides a communication link for a plurality of client devices having the second authentication from the secure access key to create connections for communication via the secure access key with the customer system.

4. The access system of claim 1, wherein the client device is a smart phone, and the smart phone receives a password to get the third authentication for the user to operate the client device.

5. The access system of claim 1, wherein the secure access key automatically detects an identification of the client device via a Bluetooth communication link.

6. The access system of claim 5, wherein upon getting the first, second and third authentications, the client device communicates over the Bluetooth communication link via the secure access key with the customer system.

7. The access system of claim 1, wherein the secure access key automatically detects an identification of the client device via a wi-fi communication link.

8. The access system of claim 7, wherein upon getting the first, second and third authentications, the client device communicates over the wi-fi communication link via the secure access key with the customer system.

9. The access system of claim 1, wherein the secure access key automatically receives an identification of the client device via a local area network (LAN) communication link.

10. The access system of claim 9, wherein upon getting the first, second and third authentications, the client device communicates over the LAN communication link via the secure access key with the customer system.

11. The access system of claim 1, wherein the secure access key automatically detects an identification of the client device via a Zigbee communication link.

12. The access system of claim 11, wherein upon getting the first, second and third authentications, the client device communicates over the Zigbee communication link via the secure access key with the customer system.

13. The access system of claim 1, wherein the footprint module receives an encrypted file from the secure access key to get the first authentication from the footprint module.

14. The access system of claim 1, wherein the footprint module limits access to a predefined set of categories of files on the customer system dependent on at least one of the first, second and third authentications.

15. The access system of claim 1, wherein the client device is a laptop.

16. The access system of claim 1, wherein the system includes an M-Port hub to connect at the port of the customer system.

17. The access system of claim 1, wherein the footprint modules is installed at the customer system.

18. A method of establishing communication with a customer system via a port at the customer system, the method comprising the steps of:
connecting a secure access key that provides a communication link to the port on the customer system;
blocking connectivity of the secure access key to communicate over the port on the customer system unless a footprint module detects the secure access key as having a first authentication to connect to the customer system;
blocking connectivity of the client device to communicate via the secure access key unless detecting a second authentication of the client device to use the secure access key; and
blocking connectivity of the client device unless detecting a third authorization of a user to operate the client device to communicate over the secure connection via the secure access key with the customer system.

19. The method of claim 18, wherein the step of getting the third authentication includes receiving a password from a user to operate the client device.

20. The method of claim 18, further comprising the step of:
the footprint module limiting access to a predefined set of categories of files on the customer system dependent on at least one of the first, second and third authentications.
